(19) United States
(12) Patent Application Publication
(10) Pub. No.: US 2022/0237019 A1
(43) Pub. Date: Jul. 28, 2022

(54) MANAGING INTERACTIONS BETWEEN STATEFUL PROCESSES

(71) Applicant: Earthbound.ai Inc., San Francisco, CA (US)

(72) Inventor: Robert BERRY, Pleasanton, CA (US)

(73) Assignee: Earthbound.ai Inc., San Francisco, CA (US)

(21) Appl. No.: 17/587,841

(22) Filed: Jan. 28, 2022

Related U.S. Application Data
(60) Provisional application No. 63/143,016, filed on Jan. 28, 2021.

(51) Int. Cl. G06F 9/46

(52) U.S. Cl. CPC G06F 9/46

(57) ABSTRACT

Systems, methods and computer program products for managing interactions between stateful processes are disclosed. A plurality of stateful processes are assembled in a cluster. Each of the stateful processes includes at least one computing object that is configured to interface with other stateful processes in the cluster. The cluster of stateful processes is used to perform a computing operation.

This application claims priority to U.S. Provisional Application No. 63/143,016, entitled “MANAGING INTERACTION BETWEEN STATEFUL PROCESSES,” filed on Jan. 28, 2021, the disclosure of which is incorporated by reference herein in its entirety for all purposes.

### BACKGROUND

Certain computing objects, such as artificial intelligence (AI) models, functions, simulations, integrations, and the like, can require significant investments in engineering and research to develop. For example, there is often considerable effort expended in the operational workflow from conception to deployment of artificial intelligence tools. There may be duplicated research and development efforts between individuals and organizations because it can be difficult to reuse computing objects developed to address one problem and transfer the code to another task. In certain cases, inefficiencies result from computing objects being incompatible with and not able to interface with other computing objects.

### SUMMARY

Systems, methods and computer program products for managing interactions between stateful processes are disclosed. A plurality of stateful processes are assembled in a cluster. Each of the stateful processes includes at least one computing object that is configured to interface with other stateful processes in the cluster. The cluster of stateful processes is used to perform a computing operation.

In various embodiments, data from the computing operation is output to one or more of a database, a widget, and an application. According to various embodiments, the process of managing interactions between stateful processes is performed in a three layer computing environment including a physical computer network layer, an overlay network layer, and a subscription network layer. The stateful processes may interface with one another using the overlay network layer.

In various embodiments, the computing object is processed to generate the stateful processes by generating a virtual machine including the computing object. Processing the computing objects to generate the stateful process may include provisioning the stateful process with services to interface with at least one of the stateful processes in the cluster.

In various embodiments, the computing object is processed to generate the stateful processes by containerizing the computing object to generate the stateful processes.

In some embodiments, the stateful processes are configured to interface with one another using one or more of application programming interfaces and software development kits.

According to various embodiments, the computing object may include a machine learning model, an artificial intelligence model, a function, a dataset, a data stream, a simulation, business logic, and an integration.

In various embodiments, the cluster of stateful processes includes an arrangement of the stateful processes in a directed graph structure.

In some embodiments, assembling the stateful processes in the cluster includes interfacing a first stateful process with a second stateful process so an output of the first stateful process provides an input to the second stateful process. In some embodiments, assembling the stateful processes in the cluster includes interfacing a first stateful process, a second stateful process, and a third stateful process so an output of the first stateful process and an output of the second stateful process provide an input to the third stateful process.

In various embodiments, multiple clusters are assembled into a meta cluster of clusters, and the meta cluster of clusters is used to perform the computing operation.

In some embodiments, an assembling step is performed at least in part in a graphical user interface.

A system may include one or more processors configured to assemble a plurality of stateful processes in a cluster and use the cluster of stateful processes to perform a computing operation. Each of the stateful processes may include a computing object that is configured to interface with other stateful processes in the cluster. The system may further include memories coupled to the processors and configured to provide the processors with instructions.

In some embodiments, the processors are configured to process the computing object to generate the stateful processes by generating a virtual machine including the computing object or containerizing the computing object to generate the stateful processes. In some embodiments, the processors are configured to interface a first stateful process with a second stateful process so an output of the first stateful process provides an input to the second stateful process. In various embodiments, the processors are configured to interface a first stateful process, a second stateful process, and a third stateful process so an output of the first stateful process and an output of the second stateful process provide an input to the third stateful process.

In various embodiments, the processors are further configured to assemble multiple clusters into a meta cluster of clusters and use the meta cluster of clusters to perform a computing operation. In some embodiments, the computing object includes one or more of a machine learning model, an artificial intelligence model, a function, a dataset, a data stream, a simulation, business logic, and an integration.

In various embodiments, a computer program product is embodied in a tangible non-transitory computer readable storage medium and includes computer instructions for assembling a plurality of stateful processes in a cluster and using the cluster of stateful processes to perform a computing operation. Each of the stateful processes includes at least one computing object that is configured to interface with other stateful processes in the cluster.

### BRIEF DESCRIPTION OF DRAWINGS

The foregoing and other features and advantages of the disclosure will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 is a flowchart illustrating embodiments of a process for managing interaction between stateful processes.

FIG. 2 is a flowchart illustrating embodiments of a process for generating a stateful process.

FIG. 3 is a diagram illustrating embodiments of a stateful process.

FIG. 4 is a flowchart illustrating embodiments of a process for assembling a cluster or project of stateful processes.

FIG. 5 is a diagram illustrating embodiments of an interface for managing stateful processes in a cluster.

FIG. 6 is a diagram illustrating embodiments of an interface for adding stateful processes to a cluster.

FIG. 7 is a diagram illustrating embodiments of an interface for monitoring stateful process and cluster execution.

FIG. 8 is a diagram illustrating embodiments of an interface for monitoring or visualizing the output of a stateful process, cluster, or project.

FIG. 9 is a diagram illustrating embodiments of a system for managing interaction between stateful processes.

FIG. 10 is a block diagram illustrating an exemplary computer system used to perform the techniques disclosed herein.

### DETAILED DESCRIPTION

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be,” and the like, are meant to include, but not be limited to, the listed examples. The terms “product” may refer to both products and services.

Disclosed herein are techniques for generating stateful processes, arranging stateful processes in clusters, interfacing stateful processes to one another in the cluster, and using the cluster to perform computing operations. Stateful processes may include computing objects that are processed (e.g., containerized, included in a virtual machine, virtualized) to interface with other stateful processes. Computing objects may include artificial intelligence models, machine learning models, functions, datasets, data streams, simulations, integrations, business logic, and/or other computer code. Stateful processes may provide various microservices to facilitate interface with other stateful processes. Stateful processes may be referred to herein as spools. Using the techniques disclosed herein, stateful processes may be combined, interfaced, and arranged into clusters (e.g., projects, meta stateful processes) for use in various computing tasks. A cluster (project) may define the relationships, interfaces, and interactions between multiple stateful processes.

The techniques disclosed herein comprise various modules including, for example, a storage system including a repository of stateful processes; a management system that governs the interactions between stateful processes in, for example, a cluster; and a user interface to manage the storage, communication between, and functionality of a cluster of stateful processes. The techniques disclosed herein also include automated modules to subdivide code into stateful processes (e.g., spools) that can be interfaced with other stateful processes.

According to various embodiments, a storage system includes a repository of stateful processes, clusters, metadata associated with stateful processes and/or clusters, computing objects, output from computer operations performed using clusters, and/or other data. In certain cases, the storage system manages and organizes the stateful processes. The stateful processes may be stored in a database. The stateful processes may be generated by various users and stored in the storage system for use by other users. The storage system may include an organizational structure that allows a user to find and access various stateful processes. For example, a stateful process may be associated with metadata that describes the functionality of the process. A user may retrieve a stateful process based on a search of the metadata. In one example, a stateful process may include a machine learning model used to predict environmental conditions, such as annual rainfall, based on a variety of environmental inputs. A user may be able to search for the model by searching, for example, “weather,” “rainfall,” or a similar term and integrate the model into a cluster.

In some embodiments, a user may be able to combine multiple stateful processes in a cluster to achieve a computing objective. The metadata associated with a stateful process may include information, such as a description of the stateful process, a coding language associated with the process, inputs and outputs to the process, types of data associated with the stateful process, and/or other information used to permit a stateful process to interface with other stateful processes.

In various embodiments, a management system controls the interaction between stateful processes. The management system may, for example, control the creation, storage, and retrieval of the stateful processes. The management system may control the interface between stateful processes. For example, stateful processes may be configured to communicate with one another in a cluster, and the management system controls such communications. The stateful processes may be combined into a cluster (e.g., a meta stateful process, project) including multiple stateful processes. Stateful processes may be combined so that an output of one stateful process provides the input of another stateful process. For example, a first stateful process may subscribe to a second stateful process, and a feed of information may be passed from the first stateful process to the second stateful process. Numerous stateful processes may be arranged in such a fashion to assemble a cluster, which may include a complex computing system. The management system (and/or an overlay network layer as described herein) may govern the arrangement of the stateful processes, the interaction between stateful processes, the communication between stateful processes, and/or the project or cluster as whole. The management system may configure the operation of stateful processes, so that the output of one stateful process is a compatible input of another stateful process. The management system may govern the allocation and scheduling of computing resources for each of the stateful processes and/or the project as a whole. The management system may govern the efficiency of messages transmitted between stateful processes. The message history (data stream history) may be managed and recorded for efficient recall and filtering.

In various embodiments, the management system includes a communication system and/or carries out communication system functionality. The communication system allows for and configures the communication of data between stateful processes. The communication system may be used to configure stateful processes in a directed graph (or tree-like structure), where outputs from stateful processes are inputs to other stateful processes up the tree culminating in, for example, a final stateful process. The tree structure may include and/or be generated by an overlay network of the stateful processes. In the cluster or tree structure, stateful processes may publish a stream of output data and other stateful processes or clusters may subscribe to that stream. The management system (and/or an overlay network layer as described herein) may govern the interface and/or communication between stateful processes to ensure compatibility and/or interoperability between processes. The management system may enable a federated environment where stateful processes are generally interoperable.

In various embodiments, the functionality of the management and storage system may be carried out through a user interface. The user interface may include a graphical interface as depicted in the diagrams below. The graphical interface may include functionality for designing, constructing, running, viewing, inspecting, and modifying a cluster of stateful processes through the management system. In certain cases, the interaction with the graphical user interface affects the relationship between stateful processes. For example, the interaction with the graphical interface determines the functionality of the underlying code. In certain cases, the interface may include data output from computing operations performed using a cluster of stateful processes. For example, the interface may include a graphical representation of data output from the computing operations, a stream of data, a spreadsheet of data, and/or any other form of data output.

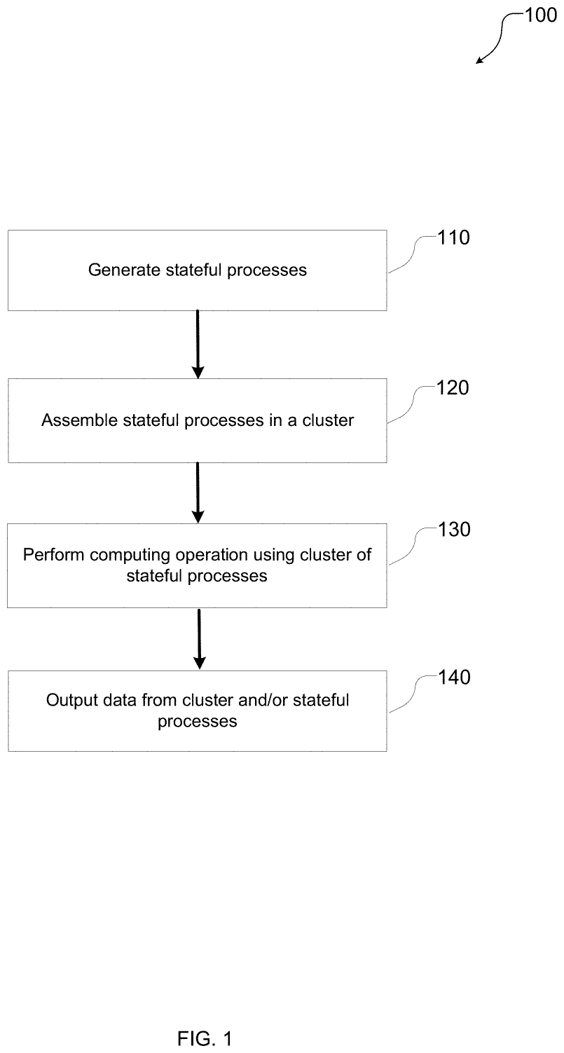

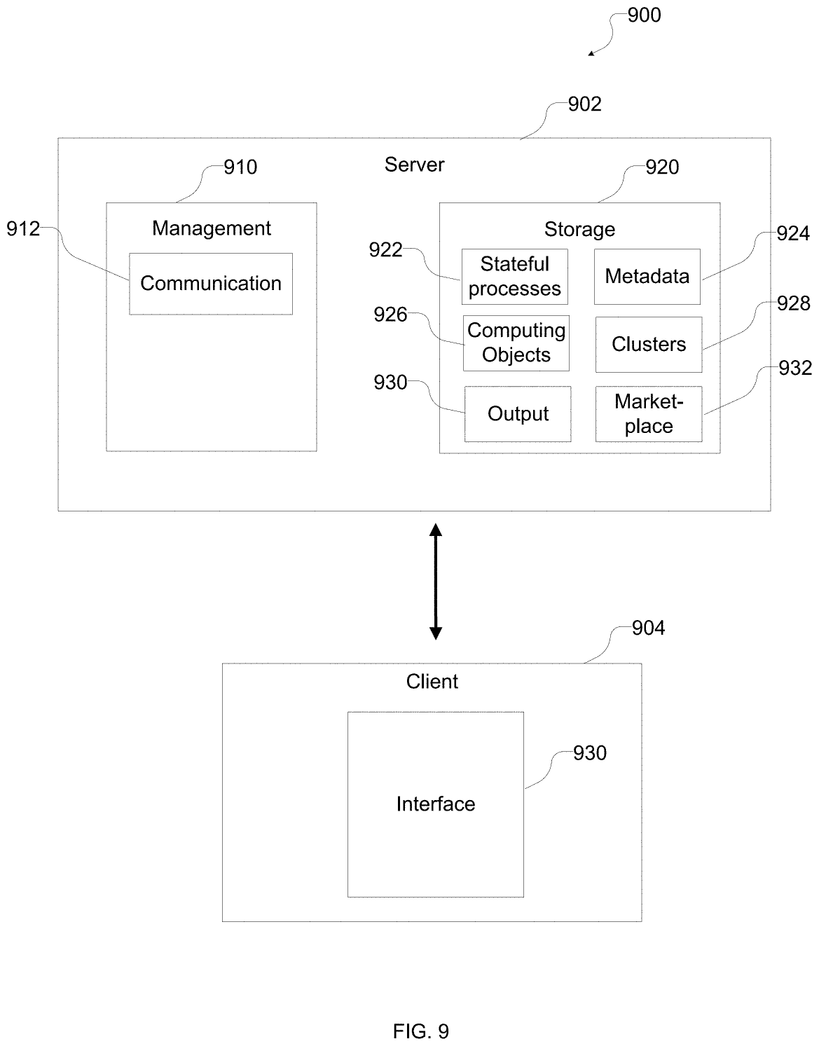

FIG. 1 is a flowchart illustrating embodiments of a process for managing interaction between stateful processes. In some embodiments, the process 100 is performed at server 900 of FIG. 9. At 110, stateful processes are generated. In various embodiments, a stateful process may include computing objects, such as machine learning models, functions, datasets, simulations, integrations, computer code, business logic, and the like, that are processed to interface with other stateful processes. In some embodiments, a stateful process may be generated automatically by analyzing a computing object to subdivide its code and containerize the code into isolated stateful processes that can be networked and controlled. Stateful processes may also be generated by including a computing object in a virtual machine and/or generating a virtual machine using the computing object. The computing object may be virtualized. Stateful processes may also be generated by provisioning the computing object with a micro kernel. The process of generating stateful processes is discussed in further detail below.

At 120, stateful processes are assembled in a cluster. Multiple stateful processes are interconnected to one another in a cluster where the output of stateful process(es) may be configured to provide input to other stateful process(es). For example, a first stateful process may subscribe to a second stateful process, and a feed of information may be passed from the first stateful process to the second stateful process. A stateful process may broadcast information to multiple stateful processes. Similarly a stateful process may receive information from multiple stateful processes. In various embodiments, the stateful processes may be arranged in a directed graph, tree, chain, hierarchical structure, and/or other arrangement. Stateful processes may be arranged in such a fashion to generate a cluster. The cluster of stateful processes may include a complex computing system.

In various embodiments, a cluster of stateful processes may include a meta stateful process. Multiple clusters (e.g., meta stateful processes) may be arranged in a cluster of clusters. In such an arrangement, the output of one cluster may be provided as the input to another cluster. For example, a first cluster (e.g., meta stateful process) may subscribe to a second cluster, and a feed of information may be passed from the first cluster to the second cluster. A cluster of clusters may include a meta cluster.

At 130, a computing operation is performed using the cluster of stateful processes. In some embodiments, a cluster of stateful processes may be used to perform a computing task, solve a complicated computing problem, and/or perform other operations. Upon assembly of the cluster, a computational process may be initiated, and the outputs of the cluster and/or the individual stateful processes may be output to another system, monitored, and/or otherwise used. In various embodiments, multiple clusters may be arranged in a cluster of clusters. The cluster of clusters may be similarly arranged in directed graph, tree, hierarchical or similar structure. And the cluster of clusters may be used to complete a computing operation.

At 140, data from a cluster and/or stateful process is output. In various embodiments, data output by a computing operation performed using a cluster is passed to a data store, a user interface, a widget, an application, and/or any other source. For example, data output from a cluster predicting environmental wear on pipes may output information representing a risk of failure. Such information may be output to a database, a widget, an application, and/or other location. In certain cases, a cluster may run continuously and an alert may be generated when output values reach a threshold. A cluster may output data in a variety of formats, for example, as specified by a user.

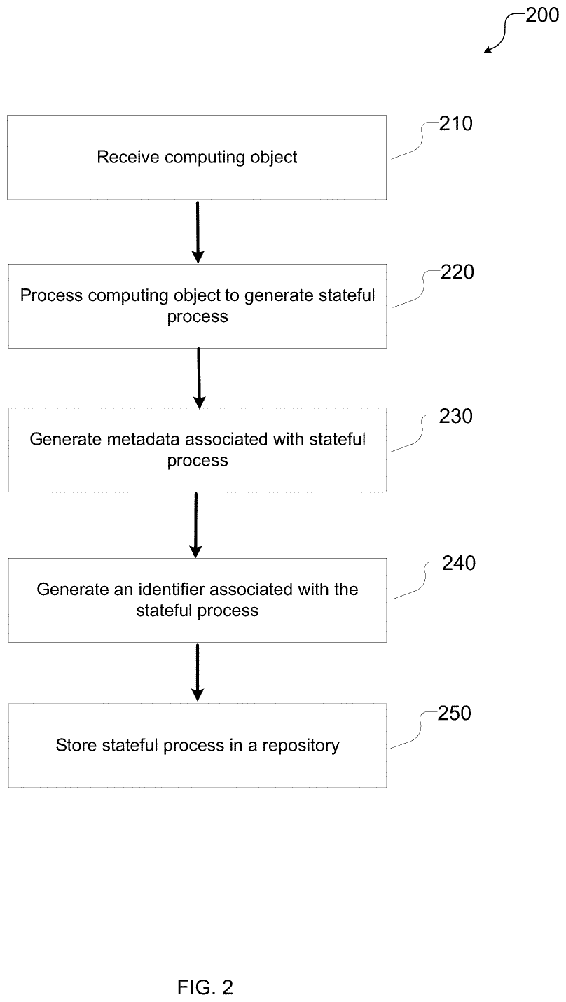

FIG. 2 is a flowchart illustrating embodiments of a process for generating a stateful process. In some embodiments, the process 200 is performed by server 902 of FIG. 9. At 210, a computing object is received. As stated herein, computing objects may include machine learning models, functions, datasets, simulations, integrations, computer code, business logic, and the like. A computing object may be received from a user, another system, and/or any other source. The computing object may be received at, for example, a server and/or management system (e.g., management system 910 of FIG. 9). In certain cases, a computing object is provided to a platform provided bya management system. A user of the platform may upload a computing object to the platform for processing. In another example, a computing object may be downloaded from a database, service, and/or other source.

At 220, the computing object is processed to generate a stateful process. The stateful process may be automatically generated using a variety of processes, which may be particular to the type of computing object. In some embodiments, the system (e.g., management system 910 of FIG. 9) may ingest a computing object (e.g., code) and divide its code. In this process, the ingested computing object is analyzed to identify portions suitable for conversion into a stateful process. For example, the computing object may be divided to isolate portions suitable for conversion into a stateful process. The identified portions of the computing object (or portions thereof) are then processed to generate a stateful processes.

In some embodiments, the computing object (or portions thereof) may be containerized to generate a stateful process. For example, a library of code may be added to the computing object to provide the computing object the features associated with a stateful process as described herein. In a stateful process generated by containerizing a computing object, operating system libraries, interface libraries, and/or any other information may be provisioned to the computing object.

In certain cases, the computing object is processed to generate a stateful process comprising a virtual machine with a computational kernel. The computing object may be virtualized. In one example, the virtual machine includes a Linux virtual machine, though other types of virtual machines by be used. The virtual machine included in the stateful process may include a central processing unit (CPU), memory, file system, disk, graphics processing unit (GPU), and/or other virtual machine components. In the process of generating the virtual machine, a computing object is processed to operate within or in conjunction with these virtual machine components. The virtual machine may be configured to provide the necessary computing resources for the computing object to process data, perform operations, and/or otherwise carry out its functionality. The virtual machine elements may also configure the computing object included in the stateful process to interface with other stateful processes. In this way, the virtual machine provides interface functionality.

In various embodiments, stateful process generation includes processing a computing object (or portions thereof) so that it can be networked (interfaced) with other stateful processes. The computing object may be augmented with virtual machine functionality, with libraries, with micro kernel features, and/or with other functionality that allow the computing object to interface with other stateful processes. The library may include hooks into the computing object code that enable the code interface with other stateful processes. In one example, a computing object included in a stateful process may be modified to include an application programming interface (API) for communication with other stateful processes. The computing object may be wrapped in a software development kit (SDK) enabling interface with other stateful processes. The computing object may be configured with a language interpreter to enable communication with other stateful processes. The computing object may be provided other interface mechanisms to enable communication with other stateful processes. In various embodiments, the API, SDK, language interpreter, and/or libraries may configure the stateful process to interface with the system (e.g., an overlay network layer), and the system (e.g., overlay network layer) may coordinate interface with other stateful processes.

In some embodiments, the process of generating a stateful process may include incorporating various microservices into the stateful process, such as beaconing functionality, gossip functionality, language interpreters, configurable host features, publishing functionality, subscription functionality, shell request capabilities, and/or other services. These services may operate in conjunction with the management system to permit interface between stateful processes.

According to some embodiments, the stateful processes may interface with other stateful processes by, for example, publishing data to other stateful processes, receiving data from other stateful processes, communicating with other stateful processes regarding status, and/or otherwise interfacing with other stateful processes.

In certain cases, the goal of stateful process generation is to configure the computing objects to be able to interface with other computing objects, regardless of differences in types of computing objects, source of computing objects, computer languages associated with computing objects, and/or other parameters. Other processing techniques may be employed to configure a computing object in a stateful process to interface with other stateful processes. For example, a stateful process may be provisioned with functionality to interface with the management system, an overlay network layer, and/or interface with other stateful process through the management system (or overlay network layer).

In some embodiments, a stateful process template may be used to generate a stateful process. For example, a computing object may be input to a pre-existing stateful process to generate a new stateful process including the computing object. The pre-existing stateful process may be updated to include the computing object, and the functionality (e.g., interface functionality, processor, memory) of the stateful process may be updated to accommodate the computing object. The newly generated stateful process may inherit the functionality and capabilities of the pre-existing stateful process. In another example, the system (e.g., management system 910 of FIG. 9) may provide template stateful processes that can be used to generate a new stateful process. In this case, a computing object is provided to the template stateful process, the computing object is processed as described herein, and the new stateful process is generated using the template.

At 230, metadata associated with the stateful process is generated. Metadata associated with a stateful process may include information, such as a description of the stateful process, a coding language associated with the process, inputs and outputs to the process, types of data input and output by the stateful process, and/or other information used to understand how the stateful process would interact with other stateful processes. The metadata may be included in a schema associated with the stateful process. Metadata associated with a stateful process may include data usable by other stateful processes to properly interface with the stateful process. In certain cases, the metadata associated with a stateful process includes the types of data the stateful process is configured to receive and/or the types of data the stateful process outputs. In one example, a stateful process may include a machine learning model for weather prediction. The input to that stateful process may include meteorological data, such as temperature, atmospheric conditions, wind speed, pressure, and/or other weather related data. The output of the stateful process may include data predicting weather conditions. These input and output data types are associated with the stateful process, and may be stored in a schema of metadata associated with the stateful process. In another example, metadata may include units (e.g., temperature in Celsius, geographic coordinates in latitude and longitude, river flow in cubic feet per second, etc.) associated with the input and/or output of the stateful process. Similarly, metadata may include topics associated with the stateful process, such as weather, atmospheric simulation, satellite imagery, publicly available data (e.g., National Oceanic and Atmospheric Administration (NOAA) weather data, stock market data, etc.), and so on. Metadata may also include the type of computing object associated with the stateful process, such as a machine learning model, data stream, function, dataset, simulation, business logic, Python code, and the like. Metadata associated with a stateful process may be associated in schema, broadcast to other stateful processes, and/or otherwise published so that other stateful processes can determine whether interface with the stateful process is possible and/or beneficial.

In various embodiments, metadata associated with a stateful process may include data related to other stateful processes. Metadata may include, for example, information regarding the location, status (e.g., active, inactive), and/or characteristics of other stateful processes. Such data may provide a directory usable by other stateful processes to locate computing resources (e.g., stateful processes) to input data from, output data to, and/or otherwise interface with.

At 240, an identifier is generated for the stateful process. In various embodiments, an identifier is automatically generated for the stateful process. The identifier may include a number, a string, and/or other identifier. In one example, the identifier may include a name such as “Spool123456.” In certain cases, the identifier may include a description related to the stateful process. For example, a stateful process may include a machine learning model for weather prediction, and the identifier may include “Weather123456” or another similar identifier. In certain cases, the identifier may be user-defined and/or adjusted by the user.

At 250, a stateful process is stored in a repository. In various embodiments, the stateful process may be stored in a storage repository, for example, associated with the management system (e.g., storage system 920 of FIG. 9). A repository may be associated with a user, group of users, organization, and/or other entity using the platform. In certain cases, a user may be associated with a repository of multiple stateful processes created by, owned by, and/or associated with that user. A user may have a personal repository of stateful processes, clusters, computing objects, and/or other data. The user may access this repository to retrieve and use stateful processes to assemble clusters as described herein.

In various embodiments, a stateful process is stored in a marketplace of stateful processes. For example, the platform may include a marketplace of stateful processes available to various users of the platform in assembling clusters of stateful processes. In certain cases, the marketplace of stateful processes may be freely available to other users. In some instances, users may have access to some stateful processes and not have access to other stateful processes. In some cases, stateful processes are provided for purchase by users. The proceeds of the purchase may be provided to the creator of the stateful process, the creator of the computing object included in the stateful process, the platform operator, and/or other entities.

According to various embodiments, users have access to a repository of their stateful processes, stateful processes generated and associated with other users, stateful processes available for purchase, and/or other computing assets. In certain cases, a user's stateful processes may be only available to that user. For example, a user's stateful processes may include proprietary information that the user does not wish to be shared with others. In this case, that user's repository (and the stateful processes stored therein) would include appropriate security and may only be accessible to that user. For example, a user may have permissions to access their stateful processes and clusters, a set of stateful processes and clusters designated to be publicly available, another set of stateful processes and clusters available for purchase in, for example, a marketplace, but the user may not have access to stateful processes and clusters that are private to other users.

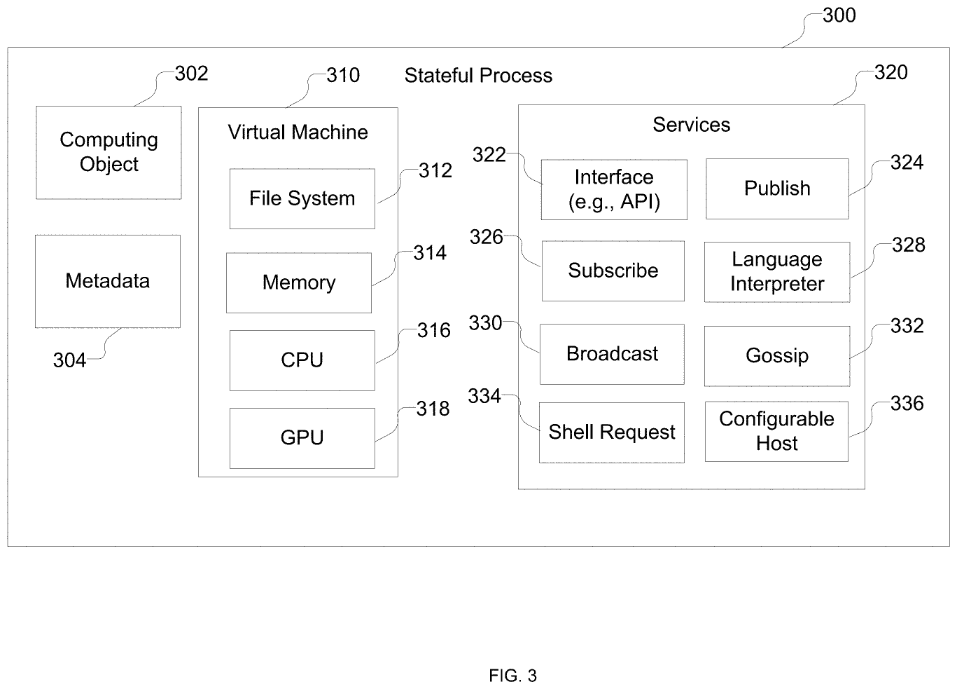

FIG. 3 is a diagram illustrating embodiments of a stateful process. In various embodiments, a stateful process includes a computer object processed to include a virtual machine with computational kernel that includes various services. In the example shown, a stateful process 300 (e.g., a spool) includes computing objects 302 (e.g., machine learning models, functions, datasets, simulations, integrations, computer code, and the like), metadata 304 associated with the stateful process, a virtual machine 310 (e.g., virtual machine components), services 320 (e.g., microservices), and/or other elements. The virtual machine 310 may include a file system 312, memory 314, central processing units (CPU) 316, graphics processing units 318, and/or other elements included in a virtual machine. The file system 312 may include any suitable type of file structure. The file system 312 may be specific to the type of computing object and/or application included in the stateful process. For example, if the stateful process 300 includes a machine learning module, the file system 312 may include NoSQL columnar databases, which are configured for fast response, high performance, and/or quick retrieval. The memory 314 is used to facilitate storage of computing objects 302 and associated data used in the stateful process 300. The CPU 316 and GPU 318 are used to carry out the computations in the stateful process 300. In certain cases, the virtual machine 310 is configured to perform any of the functions necessary to allow the stateful process 300 to interface with other stateful processes in a cluster of stateful processes.

In various embodiments, a stateful process 300 and/or virtual machine 310 includes various services 320. The services 320 may be related to facilitating interface between the stateful process 300 and other stateful processes in a cluster. In certain cases, a stateful process 300 may include an interface service 322 that allows the stateful process to communicate with other stateful processes. The interface 322 may include a library that provide hooks into the computing object 302 facilitating interface with other stateful processes. The interface 322 may include an API, an SDK, and/or interface that permits communication with other stateful processes.

A stateful process 300 may include publication services 324. A publication service 324 may communicate with other stateful processes regarding the location of certain resources. For example, if a stateful process accepts a certain type of data as input, such as temperature data, the publication service 324 may communicate with other stateful processes that publish that type of data. The publication service 324 may communicate with other stateful processes regarding status of other stateful processes in the network, such as whether the stateful processes are active, inactive, not functioning, and the like. A publication service 324 may maintain a directory of other stateful processes in the network along with the status of the stateful processes. The statuses of other stateful processes include whether a whether a stateful process is active, inactive, outputting data, last outputted data at a certain time, and/or similar status information.

In various embodiments, a publication service 324 allows the stateful process 300 to output a feed of data to other stateful processes, clusters, and/or other destinations. The publication service 324 may provide metadata 304 that indicates the type of data that the stateful process 300 outputs. For example, a stateful process may provide output from a sensor, a public data source, and similar data. In that case, the stateful process may include a data feed providing output from river waterflow gauges, and the metadata 304 may indicate that the output is in cubic feet per second (cfs). The stateful process 300 may publish the water flow data for consumption by other stateful processes. The publication service 324 may also publish the metadata 304 indicating that the output of the stateful process 300 includes data in cfs. Other stateful processes may use this metadata to determine whether to subscribe to the stateful process. In various embodiments, the publication service 324 may selectively publish data output from the stateful process 300. A history of all data generated by the stateful process 300 may be stored and provided as appropriate to other stateful processes.

A stateful process 300 may include a subscriptions service 326 (e.g., subscribe service). A subscription service 326 allows a stateful process to subscribe to other stateful processes. The subscription service 326 may determine which stateful processes include useful or appropriate data. For example, a stateful process may include a machine learning model for modeling river flow, and the stateful process may require input of water flow in cfs. The subscription service 326 may ensure that the stateful process only subscribes to (e.g., receives input from) stateful processes that output water flow data in cfs. In certain cases, a subscribing stateful process is configured to input data in a variety of different units. The subscription service 326 may seek data of a certain type (e.g., water flow data) regardless of the units (e.g., cfs, gallons per minute, etc.). The subscribing stateful process may be configured to convert data from one set of units to another set of units.

According to some embodiments, a stateful process 300 may include a language interpreter 328. A language interpreter 328 may include a computer language code interpreter (e.g., python code interpreter, JavaScript interpreter, etc.) that allows a stateful process including a computing object 302 in a first language to communicate with stateful process using other computer programming languages. The language interpreter 328 may be used to allow the stateful process 300 to interface with as many other stateful processes as possible.

In various embodiments, a stateful process 300 includes a broadcast service 330. In various embodiments, a broadcast service 330 may output a status associated with a stateful process. For example, a broadcast service 330 may output whether the stateful process is active, inactive, outputting data of a certain type, seeking data of type, etc. The broadcast service 330 may output data indicating a last time when data was output and/or processes by the stateful process 300. The broadcast service 330 may output a request for a particular type of input. For example, a stateful process may include a river model that requires input from river gauges, elevation data, and/or other sources. The broadcast service 330 may output a request seeking these data types from other stateful processes.

In some embodiments, a broadcast service 330 may output metadata 304 and/or other information related to the stateful process 300. For example, the broadcast service 330 may output the type of data that the stateful process is configured to output. This may include weather prediction data for stateful process including weather prediction models, water flow from stateful process output water flow in a river, elevation data from a stateful process providing publicly available geographic information, and so on. The broadcast service 330 may output units associated with the data that the stateful process outputs or inputs. Units could include temperature in Celsius, water flow in cfs, elevation in feet, and the like.

In some embodiments, a stateful process 300 includes a gossip service 332. In various embodiments, stateful processes may communicate with one another. A gossip service 332 may communicate with other stateful processes to determine a status of other stateful processes (e.g., whether the stateful processes are online, offline, outputting data, receiving data, and the like). A gossip service 332 is used to assess the status of stateful processes in a cluster by communicating with other stateful processes regarding the status of other stateful processes in a cluster or on the platform.

In various embodiments, a stateful process includes a shell request service 334. A shell request service 334 allows a user to interact with a stateful process in a command line interface. Using the shell request service 334, a user may modify the stateful process and/or the computing object 302 included in the stateful process 300. The shell request service 334 may allow a user to inspect the code as the stateful process 300 is active and processing data.

In some embodiments, a stateful process 300 includes a configurable host service 336. The configurable host 336 service allows a user and/or the system to configure computing resources used by the stateful process, including, for example, how much CPU, disk space, or memory access that the stateful process uses. The configurable host 336 may carry out these operations by interfacing with the overlay network layer.

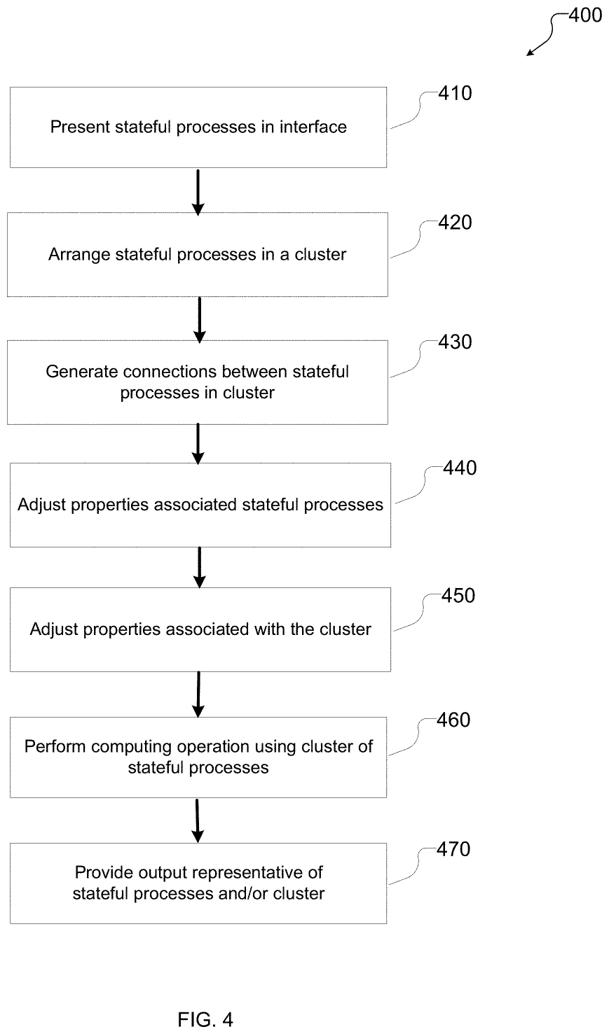

FIG. 4 is a flowchart illustrating embodiments of a process for assembling a cluster or project of stateful processes. In some embodiments, the process 400 is performed using interface 930, management system 910, and/or storage 920 of FIG. 9. In process 400, an interface is presented allowing users to combine stateful processes into a cluster. The cluster may be used to carry out complex computing operations as described herein. At 410, stateful processes are presented in an interface and/or made available to a user in an interface. In some cases, an interface may include stateful processes owned by and/or created by the user. The interface may include a repository (e.g., marketplace) including stateful processes created by other users. Some stateful processes generated by other users may be freely available to the user, while other stateful processes may be available for purchase or upon request to another party.

At 420, stateful processes are arranged in a cluster. In various embodiments, stateful processes are arranged in a directed graph (e.g., tree-like structure), where outputs from stateful processes are inputs to other stateful processes up the tree culminating in, for example, a final stateful process. The tree structure may include an overlay network of the stateful processes. In certain cases, the stateful processes are arranged in a cluster so that a first stateful process interfaces with a second stateful process so that an output of the first stateful process provides an input to the second stateful process. In another example, a first stateful process, a second stateful process, and a third stateful process are interfaced so that an output of the first stateful process and an output of the second stateful process provide an input to the third stateful process. A cluster may be arranged using any combination of stateful processes arranged using these or similar patterns. Stateful processes are arranged into a cluster as depicted, for example, interface 930 of FIG. 9.

At 430, connections are generated between the stateful processes in the cluster. In various examples, the directed graph (tree-like structure) may define connections between stateful processes. For example, in the cluster or tree structure, a stateful process may publish a stream of output data and other stateful processes may subscribe to that stream. In certain cases, stateful processes are arranged so that the output of one stateful process provides the input to one or more other stateful processes. A first stateful process may publish data, pass messages, or otherwise communicate with a second stateful process, a third stateful process, and so on. Stateful processes may be arranged so that the inputs to a stateful process are provided by one or more other stateful processes. In this way, stateful processes may subscribe to, receive messages from, and/or otherwise communicate with one or more other stateful processes.

At 440, properties associated with one or more stateful processes are adjusted. In various embodiments, properties associated with a stateful process such as configuration data may be adjusted in, for example, a properties interface. Configuration data may include, for example, model parameter values associated with machine learning model included in the stateful process; subscription data, the type of date output by the stateful process, where to find the stateful process, and similar data; data regarding the code running in the stateful process, such what computer language, any errors in the code, and the like; data regarding computing resources available to the stateful process, such as CPU resources, memory, and other computing resources; data regarding the state of the stateful process, such as currently processing data, paused, and similar data; and/or any other data useable to configure the stateful process. Properties may also include the types of data input and output by the stateful process, units associated with the data input and output by the stateful process, and/or other similar data.

At 450, properties associated with a cluster are adjusted. In various embodiments, properties associated with a cluster such as configuration data may be adjusted in, for example, a properties interface. Configuration data associated with a cluster may include the same types of configuration data applicable to the stateful process. The configuration data associated with the cluster may be applicable to the cluster (meta stateful process) as a whole.

In various embodiments, steps 440 and 450 may be performed in parallel with, after, and/or before the other steps in process 400. For example, properties associated with stateful processes and/or clusters may be adjusted while computing operations are performed using the cluster (e.g., as described in step 460).

At 460, computing operations are performed using the cluster of stateful processes. In various embodiments, once stateful processes are arranged in a cluster, connections are defined between the stateful processes, and/or properties adjusted, computing operations may be initiated. For example, stateful processes may be arranged in a directed graph (e.g., tree-like structure), and the outputs from stateful processes are inputs to other stateful processes up the tree culminating in, for example, a final stateful process. The output of the final stateful process may include the output of the computing operation performed using the cluster. In certain cases, the stateful processes may be continuously updating with new data and the output of the cluster may include a continuous stream of data.

At 470, output representative of stateful processes and/or the cluster is provided. In various embodiments, the cluster may output data to a system, a user's interface, a widget that provides continuous output in user's interface, a dashboard, and/or other location. In certain cases, a cluster may output data to another stateful process in another cluster for use in, for example, another computing operation or project. In some embodiments, output may be provided to a database, a separate system, a dashboard, a widget, an application, and/or other location. In certain cases, the output of a cluster and/or stateful processes may be inspected in the cluster interface, and the output may be presented in graphical form, in a command-line type interface, a data stream, and/or other form of data output.

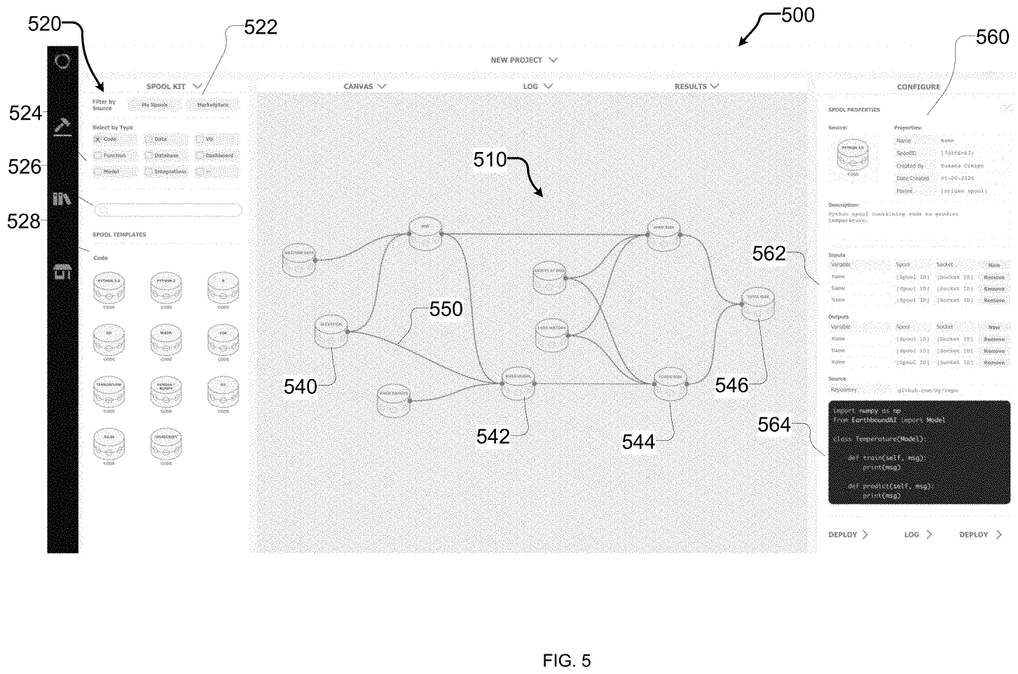

FIG. 5 is a diagram illustrating embodiments of an interface for managing stateful processes in a cluster. In the example shown, an interface 500 for managing and designing a computing project is depicted. The project design interface 500 allows for arrangement of stateful processes 540, 542, 544, 546 into clusters 510. A stateful processes store (e.g., model repository, spool store/repository) 520 includes an inventory of stateful processes that can be added to a cluster 510. The store 520 may allow the user to filter 522 stateful processes owned by the user, stateful process available in a marketplace, stateful processors provided by the platform, and/or other stateful processes from other sources. The store 520 may include an interface to filter 524 stateful process by type including, for example, code type, data, visualization, functions, databases, dashboard, machine learning models, integrations, and/or other types of stateful process. The store 520 may include an interface to search 526 for stateful processes. A user may search for stateful process by keywords associated with function of the stateful process, by computing object type, by type of code used in the stateful process, and/or by other parameters. In certain cases, the store 520 may include stateful process templates 528 that can be used to create new stateful processes. The stateful process templates 528 may include code templates in various languages, such as Python, R, Go, Tensorflow, and/or other languages, that can be modified to create new stateful processes.

In various embodiments, stateful processes 540, 542, 544, 546 are assembled into the cluster 530 in the interface 500. The stateful processes 540, 542, 544, 546 may be dragged and dropped into position and/or automatically positioned relative to one another in the interface. The stateful processes 540, 542, 544, 546 are connected to one another in the interface. The Connections 550 represent information flow (e.g., a stream of data, a subscription to a feed, etc.) between the stateful processes 540, 542, 544, 546. For example, the stateful process may be arranged such that the output from a first stateful process 540 may be the input to a second stateful process 542. The second stateful process 542 may receive inputs from multiple stateful processes. A stateful process 540 may provide output to multiple stateful process. In the example shown, the dots on the stateful processes (spools) indicate inputs and/or outputs to the stateful processes. The output of the second stateful process 542 may be an input of the third stateful process 544. The output of the third stateful process 544 may be the input a fourth stateful process 546. And the output of the fourth stateful process 546 may include the output of the cluster or project 510.

In various embodiments, the interface 500 includes a properties interface 560. The properties interface 560 may include an interface that displays properties of the cluster and/or a particular stateful process. In the example shown, the properties interface displays properties associate with a stateful process, including, for example, a name of the stateful process, an identifier associated with the stateful process (e.g., a spoolID), information identifying the creator of the stateful process, a date the stateful process was created, a description of the stateful process, and/or other information.

In some embodiments, the properties interface 560 includes a display 562 of data describing the inputs to and outputs from the stateful process. For example, a list of inputs may include names of variables input to the stateful process, other stateful processes that provide input to the stateful process, sockets which are receiving input from other stateful processes, and/or other information. Similarly, a list of outputs may include names of variables output from the stateful process, other stateful processes that are receiving data from the stateful process, sockets through which data is output from the stateful process, and/or other information.

According to various embodiments, the properties interface 560 may include a display of the code 564 included running in the stateful process. In certain cases, a user may be able to monitor the code running in the stateful process. The user may also be permitted to manipulate the code running in the stateful process.

In various embodiments, the properties interface 560 permits adjustment of properties associated with a cluster (project) including, for example, name, descriptions of the project, metadata, organizations associated with the project, access control information associated with the project (e.g., which users can access the project), information related to the overlay network leveraged by the system, and resource management information. The properties 560 may also define the computer resources allocated to one or more of the stateful process 540, 542, 544, 546, the cluster 530, and/or combinations of the same.

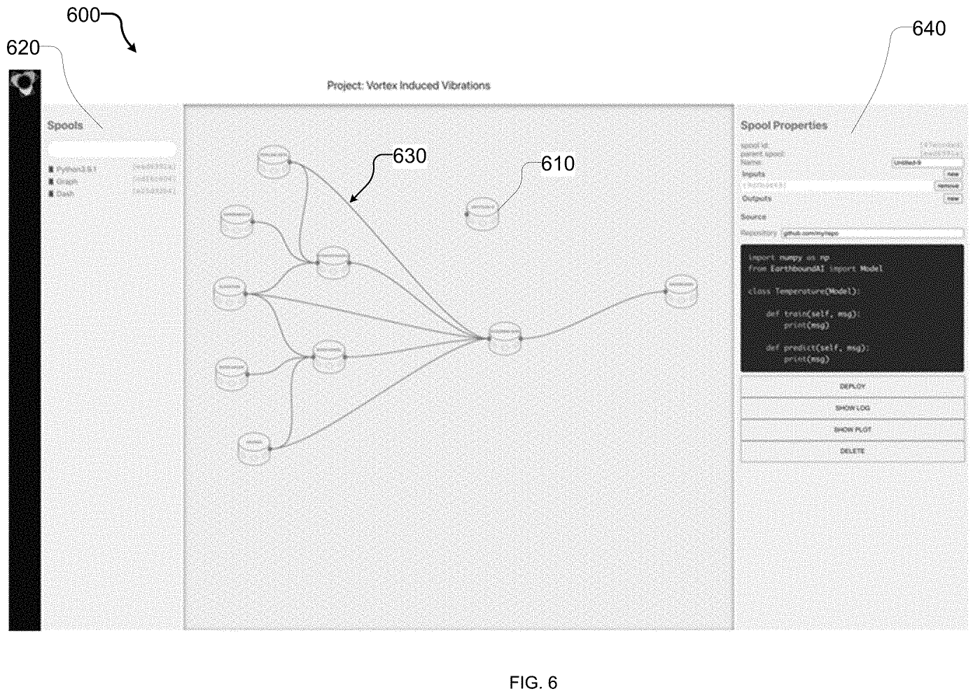

FIG. 6 is a diagram illustrating embodiments of an interface for adding stateful processes to a cluster. In the example shown, a stateful process (e.g., a spool) 610 is selected from the store (e.g., repository, stateful process store/repository) 620. The stateful process 610 is inserted (e.g., by drag and drop, automatically) into a cluster 630 of stateful processes. The stateful process 610 may be, for example, connected to other stateful processes. The stateful process 610 may be added into the cluster so that it receives input (e.g., a stream of data) from one or more stateful processes and outputs data (e.g., a stream of data) to other stateful process in the cluster 630. The interface 600 may include a properties interface 640 to adjust properties associated with a stateful process. For example, by clicking on or selecting a stateful process 610, the properties interface 640 may appear. The properties 640 associated with a stateful process may include description of the stateful process, the data source of the stateful process, type of data that the stateful process inputs and outputs, the code associated with the stateful process, metadata associated with the stateful process, and/or other information.

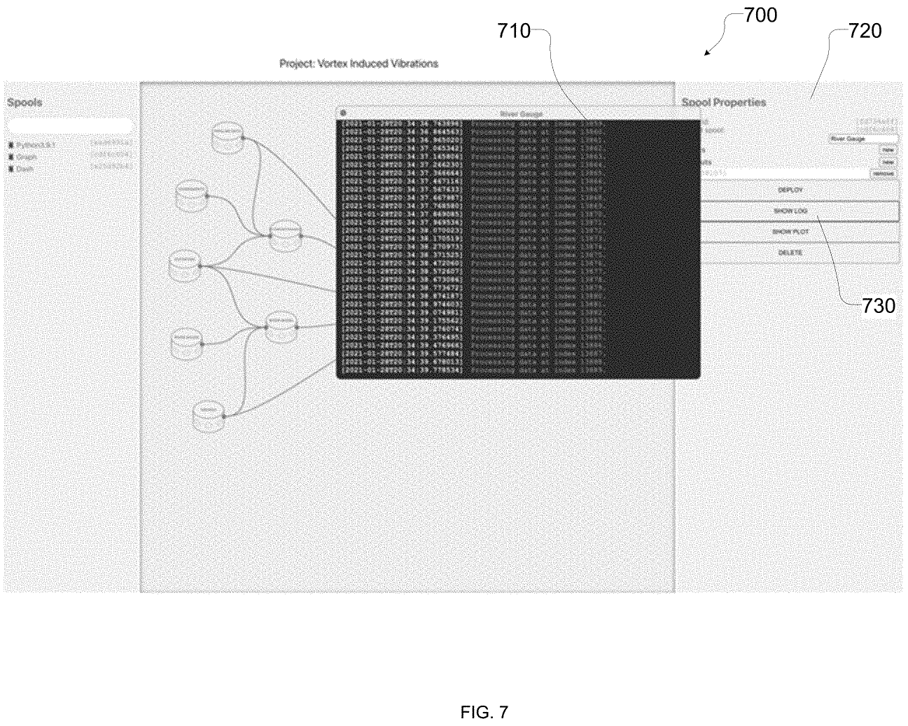

FIG. 7 is a diagram illustrating embodiments of an interface for monitoring stateful process and cluster execution. In the example shown, an interface 700 for monitoring a computing operation performed by a cluster of stateful processes includes a representation of code running in a stateful process. In the example shown, an interface 700 displays a live feed 710 (e.g., a representation) of the code running inside a stateful process. The live feed 710 may be accessed by selecting a stateful process in the cluster. A properties display 720 may include a button 730 that shows the log of information input to and/or output from the stateful process. In one example, a user can select a stateful process in a cluster and a feed of the status codes, logs, and/or other information from the running stateful process is displayed. The interface 700 may be used to inspect the operation of stateful processes executing within a cluster (project) for troubleshooting, bug detection, education regarding the functioning of the cluster, and/or other purposes. Such functionality allows a user to inspect the inner workings of a stateful process.

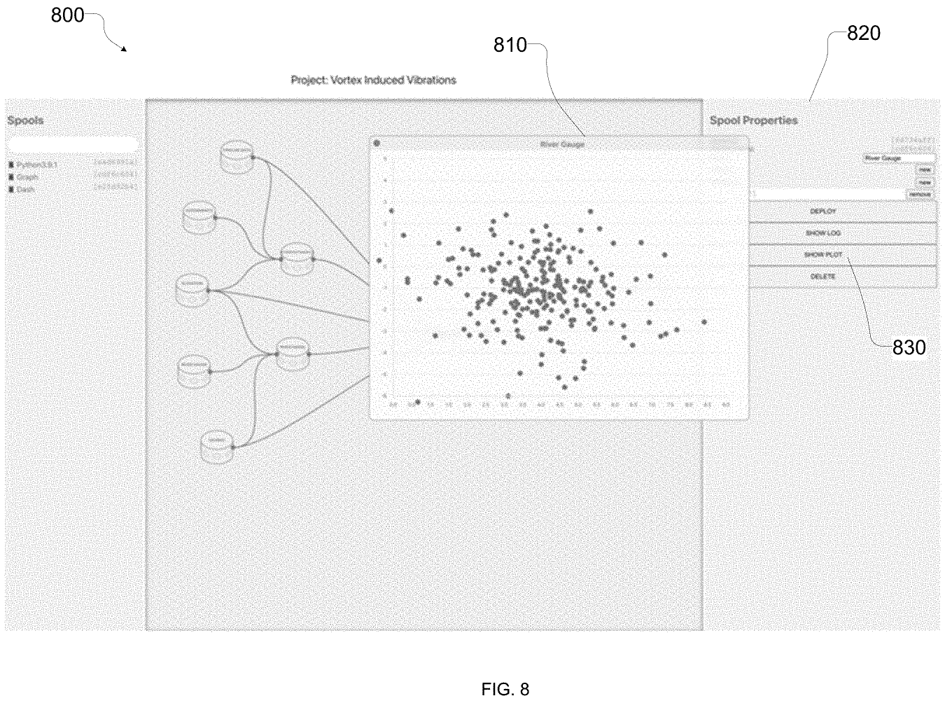

FIG. 8 is a diagram illustrating embodiments of an interface for monitoring or visualizing the output of a stateful process, cluster, or project. In the example shown, an interface 800 includes a visualization 810 of the information output from a stateful process and/or a cluster. In the example shown, a user may select a connection between stateful processes, and the visualization 810 depicts the data flowing from a first stateful process to a second stateful process. Such functionality could be used for troubleshooting, bug detection, education regarding the functioning of the cluster, and/or other purposes.

FIG. 9 is a diagram illustrating embodiments of a system for managing interaction between stateful processes. In the example shown, the system includes a server 902 and one or more clients 904. The server 902 may include a management system 910, storage system 920, and/or other elements. The management system 910 governs the generation of stateful processes. For example, the management system 910 may include modules to subdivide computing objects into stateful processes, process the computing objects to generate interface capabilities, provision the computing object to include virtual machine features, provision the code to include services described herein, and/or perform other operations to generate stateful processes. The management system 910 may control the storage of stateful processes, computing objects, clusters, and associated metadata in the storage repository. The management system 910 may control the interface between stateful processes in a cluster as described herein. For example, the management system 910 may govern the arrangement of the stateful processes in a cluster, the interaction between stateful processes in the cluster, the communication between stateful processes in the cluster, and/or the project or cluster as whole.

In various embodiments, the management system 910 may govern the allocation and scheduling of computing resources for each of the stateful processes and/or a cluster as a whole. The management system 910 may govern the efficiency of messages transmitted between stateful processes. The message history (data stream history) is managed and recorded for efficient recall and filtering.

In various embodiments, the management system 910 includes a communication system 912. The communication system 912 allows for and configures the communication of data between stateful processes. The communication system 912 may be used to configure stateful processes in a directed graph (or tree-like structure), where outputs from stateful processes are inputs to other stateful processes up the tree culminating in, for example, a final stateful process. The tree structure may include an overlay network of the stateful processes. In the cluster or tree structure, stateful processes may publish a stream of output data and other stateful process may subscribe to that stream. The management system 910 may govern the interface and/or communication between stateful processes to ensure compatibility and/or interoperability between processes. The management system 910 may enable a federated environment where stateful processes are generally interoperable.

In various embodiments, the storage system 920 may store stateful processes 922, metadata 924 associated with the stateful processes, computing objects 924 included within the stateful processes, clusters 928 (e.g., projects) of stateful processes, output 930 from stateful processes and/or clusters, marketplace 932 data to present stateful processes in a marketplace, and/or other information. The arrangement of and/or access to the storage system 920 may be controlled by the management system 910.

In various embodiments, a client system 904 includes an interface 930 to interact with the management system 910 and storage system 920 to carry out the functionalities described herein. The interface 930 may include a graphical interface. The graphical interface may include functionality for designing, constructing, running, viewing, inspecting, and modifying a cluster of stateful processes through the management system, as depicted in, for example, FIGS. 5-8.

According to various embodiments, the techniques disclosed herein interact with and improve the function of a three-layer computing environment. A first layer of the computer environment includes a physical computer network in a data center. A second layer includes an overlay network on top of hardware. For example, the overlay network may include a virtual local area network that connects stateful processes and clusters together. The overlay network may provide the medium for and the functionality for stateful processes to send and receive data. A stateful process may, for example, interface with the overlay network using an SDK, API, and/or other interface to connect to other stateful processes. In one example, a stateful process may include and/or contain a virtual machine. The virtual machine may interface with the overlay layer to configure computing resources, storage, and the like to facilitate the computing object processing operations carried out in and/or using the virtual machine. A virtual machine may include services that interface with the overlay layer to pass data to and receive data from other stateful processes. In various embodiments, the overlay network layer mediates interface and/or communication between stateful processes within a cluster, between stateful processes across multiple clusters, between clusters, and/or across a network including stateful processes and clusters. In certain cases, the overlay layer coordinates processing, data transfer, message passing, and/or other operations across clusters and/or projects associated with multiple users (and/or organizations). The overlay layer may mediate security, auditing, monitoring, compatibility, and/or other operations between stateful processes, clusters, and/or projects associated with various users and organizations interacting with the system. The overlay layer facilitates scalability of the stateful process and/or cluster computing process described herein across of a large network of computing environments.

In various embodiments, the third layer includes a subscription network visualized in browser (e.g., interface 930 of FIG. 9). A user may interface with the subscription layer in performing the processes described herein. Using the techniques disclosed herein, the three layers allow the techniques disclosed herein to be scaled in, for example, a federated structure.

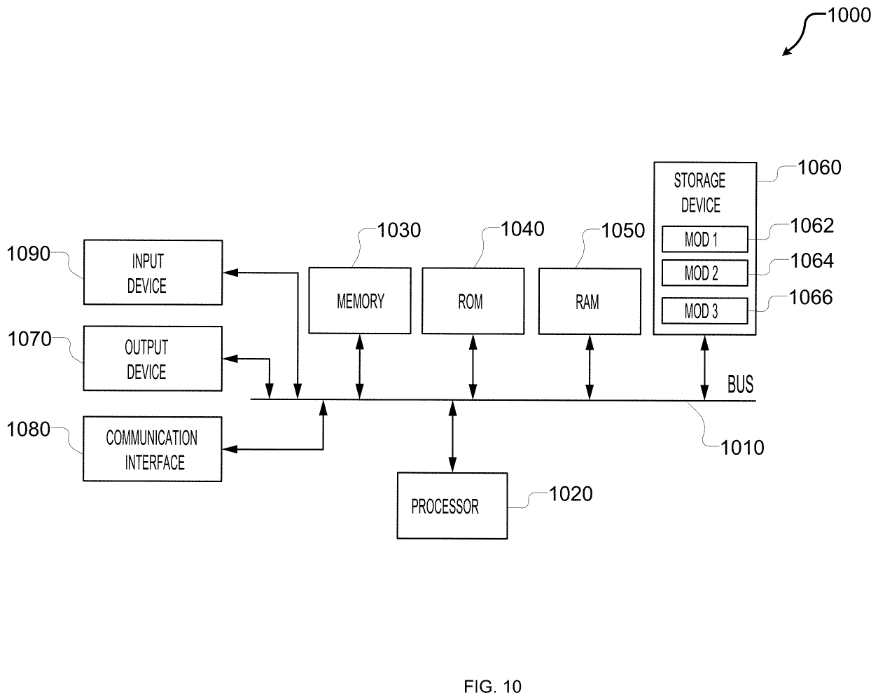

FIG. 10 is a block diagram illustrating an exemplary computer system used to perform the techniques disclosed herein. With reference to FIG. 10, an exemplary system 1000 may include computing device, including a processing unit (CPU or processor) 1020 and a system bus 1010 that couples various system components including the system memory 1030 such as read-only memory (ROM) 1040 and random-access memory (RAM) 1050 to the processor 1020. The system 1000 may include a desktop computer, thin client, mobile device (e.g., a smart phone, computing device) including applications, telecommunications capabilities, and/or other components. The system 1000 may also include servers, cloud computing components, and/or other computing devices. The system 1000 can include a cache of high-speed memory connected directly with, in close proximity to, or integrated as part of the processor 1020. The system 1000 copies data from the memory 1030 and/or the storage device 1060 to the cache for quick access by the processor 1020. In this way, the cache provides a performance boost that avoids processor 1020 delays while waiting for data. These and other modules can control or be configured to control the processor 1020 to perform various actions. Other system memory 1030 may be available for use as well. The memory 1030 can include multiple different types of memory with different performance characteristics. It can be appreciated that the disclosure may operate on a computing device 1000 with more than one processor 1020 or on a group or cluster of computing devices networked together to provide greater processing capability. The processor 1020 can include any general-purpose processor and a hardware module or software module, such as module one 1062, module two 1064, and module three 1066 stored in storage device 1060, configured to control the processor 1020 as well as a special-purpose processor where software instructions are incorporated into the actual processor design. The processor 1020 may essentially be a completely self-contained computing system, containing multiple cores or processors, a bus, memory controller, cache, etc. A multi-core processor may be symmetric or asymmetric.

The system bus 1010 may be any of several types of bus structures including a memory bus or memory controller, a peripheral bus, and a local bus using any of a variety of bus architectures. A basic input/output (BIOS) stored in ROM 1040 or the like, may provide the basic routine that helps to transfer information between elements within the computing device 1000, such as during start-up. The computing device 1000 further includes storage devices 1060 such as a hard disk drive, a magnetic disk drive, an optical disk drive, tape drive, or the like. The storage device 1060 can include software modules 1062, 1064, 1066 for controlling the processor 1020. Other hardware or software modules are contemplated. The storage device 1060 is connected to the system bus 1010 by a drive interface. The drives and the associated computer-readable storage media provide nonvolatile storage of computer-readable instructions, data structures, program modules and other data for the computing device 1000. In one aspect, a hardware module that performs a particular function includes the software component stored in a tangible computer-readable storage medium in connection with the necessary hardware components, such as the processor 1020, bus 1010, display 1070, and so forth, to carry out the function. In another aspect, the system can use a processor and computer-readable storage medium to store instructions that when executed by the processor, cause the processor to perform a method or other specific actions. The basic components and appropriate variations are contemplated depending on the type of device, such as whether the device 1000 is a small, handheld computing device, a desktop computer, or a computer server.

Although the exemplary embodiment described herein employs the hard disk 1060, other types of computer-readable media which can store data that are accessible by a computer, such as magnetic cassettes, flash memory cards, digital versatile disks, cartridges, random access memories (RAMs) 1050, and read-only memory (ROM) 1040, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1000, an input device 1090 represents any number of input mechanisms, such as a microphone for speech, a touch-sensitive screen for gesture or graphical input, keyboard, mouse, motion input, speech and so forth. An output device 1070 (display) can also be one or more of a number of output mechanisms known to those of skill in the art. In some instances, multimodal systems enable a user to provide multiple types of input to communicate with the computing device 1000. The communications interface 1080 generally governs and manages the user input and system output. There is no restriction on operating on any particular hardware arrangement and therefore the basic features here may easily be substituted for improved hardware or firmware arrangements as they are developed.

### Example Implementation

In various embodiments, an example use case for the techniques disclosed herein may be a cluster to predict corrosion in pipes. With reference to the cluster 510 of FIG. 5, stateful processes may be generated based on data streams of weather data, of elevation data, data streams from an entities' river gauges, and/or other sources. A weather research and forecasting (WRF) model, river model, wind risk model, and flood risk model may be processed to generate stateful processes. Computing objects related to the assets (e.g., pipes) and loss history related to the assets are used to generate stateful processes. The stateful processes are arranged into a cluster, for example, as depicted in FIG. 5. In the cluster, an WRF stateful process may receive input from weather data feed and elevation data feed stateful processes. The WRF stateful process may output data forecasting a variety of weather conditions. A river model stateful process receives data from the WRF stateful process, the elevation data feed stateful process, and the river gauge data feed stateful process. The river model stateful process may output data describing the flow of water through a river, the contours of the river, the geography of the river, and similar data. A wind risk model may receive data from the WRF model stateful process, the asset stateful process, and loss history of the asset state process. Based on these inputs, the wind risk model may output data predicting risk associated with the wind (such as high wind effects) on the assets. The flood risk model stateful process may receive data from the river model stateful process, the asset stateful process, and loss history of the asset stateful process. The flood risk model stateful process may output data representative of potential flood risk for the asset. The output of the flood risk model stateful process and the wind risk model stateful process may be input to a total risk model stateful process. The total risk model may aggregate the total risk to the asset. The output of the total risk stateful process may include a risk score, data quantifying risk, an alert when risk exceeds a threshold, and/or other data. The output of the total risk model stateful process may include the output of the cluster. The output may be provided to a database, an application, another statement, a dashboard (e.g., providing alerts or a representation of a data feed), and/or another location. In certain cases, the corrosion risk model may run continuously and provide output continuously to, for example, a database, application, widget, and/or other destination.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may. The various embodiments described herein may be combined and/or features of the embodiments may be combined to form new embodiments.

Unless specifically stated otherwise, as apparent from the following discussions, it is appreciated that throughout the specification discussions utilizing terms such as “processing,” “assembling,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. A general purpose computer may be specialized by storing programming logic that enables one or more processors to perform the techniques disclosed herein.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents. The embodiments of the invention that have been de-scribed above may contain features that may be removed or combined between the described embodiments to derive additional embodiments.

What is claimed is:

1. A method, comprising:
assembling a plurality of stateful processes in a cluster, wherein each of the stateful processes includes at least one computing object that is configured to interface with other stateful processes in the cluster; and
using the cluster of stateful processes to perform a computing operation.

2. The method of claim 1, further comprising outputting data from the computing operation to one or more of a database, a widget, and an application.

3. The method of claim 1, wherein:
the steps of the process are performed in a three layer computing environment including a physical computer network layer, an overlay network layer, and a subscription network layer; and
the stateful processes interfaces with one another using the overlay network layer.

4. The method of claim 1, further comprising processing the computing object to generate the stateful processes by generating a virtual machine including the computing object.

5. The method of claim 4, wherein processing the computing objects to generate the stateful process further includes provisioning the stateful process with services to interface with at least one of the stateful processes in the cluster.

6. The method of claim 5, further comprising processing the computing object to generate the stateful processes by containerizing the computing object to generate the stateful processes.

7. The method of claim 1, wherein the stateful processes are configured to interface with one another using one or more of application programming interfaces and software development kits.

8. The method claim 1, wherein the computing object comprises one or more of a machine learning model, an artificial intelligence model, a function, a dataset, a data stream, a simulation, business logic, and an integration.

9. The method of claim 1, wherein the cluster of stateful processes includes an arrangement of the stateful processes in a directed graph structure.

10. The method of claim 1, wherein assembling the plurality of stateful processes in the cluster includes interfacing a first stateful process with a second stateful process so an output of the first stateful process provides an input to the second stateful process.

11. The method of claim 1, wherein assembling the plurality of stateful processes in the cluster includes interfacing a first stateful process, a second stateful process, and a third stateful process so an output of the first stateful process and an output of the second stateful process provide an input to the third stateful process.

12. The method of claim 1, further comprising:
assembling the cluster and at least one other cluster into a meta cluster of clusters; and
using the meta cluster of clusters to perform the computing operation.

13. The method of claim 1, wherein the assembling step is performed at least in part in a graphical user interface.

14. A system, comprising:
one or more processors configured to:
assemble a plurality of stateful processes in a cluster, wherein each of the stateful processes includes at least one computing object that is configured to interface with other stateful processes in the cluster; and
use the cluster of stateful processes to perform a computing operation; and
one or more memories coupled to the one or more processors and configured to provide the one or more processors with instructions.

15. The system of claim 14, wherein the processors are configured to process the computing object to generate the stateful processes by one or more of generating a virtual machine including the computing object and containerizing the computing object to generate the stateful processes.

16. The system of claim 14, wherein to assemble the plurality of stateful processes in the cluster the processors are configured to interface a first stateful process with a second stateful process so an output of the first stateful process provides an input to the second stateful process.

17. The method of claim 14, wherein to assemble the plurality of stateful processes in the cluster the processors are configured to interface a first stateful process, a second stateful process, and a third stateful process so an output of the first stateful process and an output of the second stateful process provide an input to the third stateful process.

18. The system of claim 14, wherein the processors are further configured to:
assemble the cluster and at least one other cluster into a meta cluster of clusters; and
use the meta cluster of clusters to perform the computing operation.

19. The system of claim 14, wherein the computing object comprises one or more of a machine learning model, an artificial intelligence model, a function, a dataset, a data stream, a simulation, business logic, and an integration.

20. A computer program product being embodied in a tangible non-transitory computer readable storage medium and comprising computer instructions for:
assembling a plurality of stateful processes in a cluster, wherein each of the stateful processes includes at least one computing object that is configured to interface with other stateful processes in the cluster; and
using the cluster of stateful processes to perform a computing operation.
